(19) United States
(12) Patent Application Publication
(10) Pub. No.: US 2013/0263895 A1
(43) Pub. Date: Oct. 10, 2013

(54) CVD REACTOR CLEANING METHODS AND SYSTEMS

(71) Applicants: Jae Chull Lee, Coppell, TX (US); Jong Hyuck Lee, Seoul (KR); Jae Min Lee, Incheon (KR); Jung Hun Lee, Seoul (KR)

(72) Inventors: Jae Chull Lee, Coppell, TX (US); Jong Hyuck Lee, Seoul (KR); Jae Min Lee, Incheon (KR); Jung Hun Lee, Seoul (KR)

(21) Appl. No.: 13/441,127

(22) Filed: Apr. 6, 2012

(51) Int. Cl. B08B 9/08

(52) U.S. Cl. 134/22.1; 134/166 R

(57) ABSTRACT

A portable cleaning system for a CVD reactor. The cleaning system comprises two components: (1) a stand-mounted gloved box assembly for mounting a flow flange or shower head of a CVD reactor thereto, and (2) a gloved device such as a gloved flange or gloved cylinder for mounting to the reactor chamber. Both components can be equipped with a filtration device for capturing particles that are cleaned out of the CVD reactor. Both systems can be purged with an inert gas to guard against pyrophoric reactions. The system can be used for cleaning existing CVD reactors without the need for costly modification of the CVD reactor to accommodate the cleaning equipment. Also, one cleaning system can be used to service several CVD reactors.

### FIELD OF THE INVENTION

The disclosure is directed generally to chemical vapor deposition (CVD) maintenance equipment, and more specifically to cleaning equipment for CVD reactors.

### BACKGROUND

Metalorganic Chemical Vapor Deposition (MOCVD) is a chemical vapor deposition technique for growing crystalline layers in processes such as the production of semiconductors. The MOCVD process is implemented in a reactor chamber with specially designed flow flanges that deliver uniform reactor gas flows to the reactor chamber. During the MOCVD process, the interior surfaces of the reactor chamber and flow flange experience a build up of MOCVD materials that eventually compromise performance. Preventative maintenance of the reactor chamber and flow flange is thus required.

Presently, during preventative maintenance of CVD equipment, service personnel manually clean out the reactor residue by hand using wipes. Many facilities require the service personnel to wear a respirator during the cleaning operation because of airborne particles that are generated during the cleaning operation. The airborne particles are an inhalation hazard as well as containing hazardous residue which results from CVD processes. Also, the residue in CVD reactors can be pyrophoric and ignite when exposed to the oxygen in the air, posing an additional danger to service personnel. The cleaning process produces particles that can damage nearby equipment such as DC power supplies and computers, and compromise the cleanliness of the surroundings generally.

Some facilities enclose the CVD reactor in a clear plastic module that can then be pressurized with nitrogen during the cleaning operation. Such devices are disclosed, for example, in JP Patent Publication No. 2007-208097 to Yoshiaki et al. and JP Patent Publication No. 2005-236093 to Akira et al. With these systems, service personnel manually clean out the residue by hand through gloved access ports using wipes and compressed air. At the end of the cleaning process, service personnel typically need to remove all the wipes and the particulates that collect inside the module. These CVD systems, however, require built-in appurtenances on each CVD reactor to accommodate the cleaning system. Retrofitting existing CVD reactors with such appurtenances would be costly.

What is needed are cleaning methods and apparatuses that eliminate or greatly reduce the production of particles and their introduction into the ambient environment and abates and the associated risks and dangers posed to service personnel.

### SUMMARY OF THE INVENTION

Various embodiments of the invention safely remove and clean out CVD reactor and/or flow flanges without residue ignition (burning or fire) during routine maintenance and the attendant issues associated with particle generation in the cleaning room environment. The various embodiments also facilitate easy disposal of the cleaning byproduct from the CVD reactor. In one embodiment, the cleaning is semi-automatic and requires no auxiliary electrical power. The apparatus and process fully cleans the CVD reactor and flow flange without contamination of the ambient surroundings, enabling the preventative maintenance of the reactor and flow flange, also known as a “showerhead”, to take place in the vicinity of the reactor module assembly RMA. Embodiments of the present invention can be used to clean existing CVD reactors without the need for costly modifications thereto as required by prior art approaches.

Structurally various embodiments of the invention utilize a gloved box, gloved flange or gloved cylinder having a purge port through which a nitrogen purge is introduced and a suction port which can maintain the microenvironment at a pressure that is below ambient. The evacuated croenvironment carries away the particulates generated during the cleaning process. Also, the suction port can be attached a vacuum nozzle or vacuum brush for direct removal of the particulates. The evacuated flows are routed through filters or filter systems that capture volatile particulates for safe disposal.

In one embodiment, the subject cleaning system comprises two separate cleaning apparatuses: (1) a stand having the gloved box adapted to receive a flow flange of a CVD reactor, and (2) the gloved flange or gloved cylinder adapted to fit over a CVD reactor chamber. To implement this embodiment, the stand is transported and positioned next to a CVD reactor and the flow flange of the CVD reactor removed from the reactor chamber and placed on the stand in a sealed arrangement. The flow flange is then cleaned by an operator using the gloved box. The gloved box can be purged with an inert gas (e.g., nitrogen) during the cleaning operation.

The gloved flange/cylinder is placed over the reactor chamber in place of the removed flow flange and used to clean the interior of the reactor chamber. The gloved flange/cylinder can include a purge port and a suction port to maintain a negative, inert gas environment within the reactor chamber during cleaning. A heater shield can also be provided for protection of the heating elements that are exposed by the removal of the flow flange during the cleaning operation.

The vacuum sources for the gloved box and the gloved flange/cylinder can be provided by a stand-alone vacuum source or by connecting directly to the clean room or tab exhaust system. The filters remove the bulk of the particulates, thereby protecting the vacuum source from undue exposure to the volatile particulates.

Various embodiments include a system for cleaning a CVD flow flange with a flow flange having a chamber-facing surface, the system including a gloved box comprising one or more walls, at least one of the one or more walls including a suction port and an access port, the access port having a wall-mounted glove coupled thereto. A filter device includes an intake and an exhaust, the intake of the filter device being configured for operative coupling with the suction port of the gloved box. A mounting plate adapted to releasably couple the flow flange to the gloved box is also included such that the chamber-facing surface of the flow flange is substantially sealed against the mounting plate. One or more retrievable cleaning implements adapted to clean the chamber facing surface of the flow flange can also be included. In one embodiment, a vacuum device configured for operative coupling with the exhaust of the filter device is also included, wherein a vacuum is maintained within the gloved box by the vacuum device when the flow flange is coupled to the mounting plate. The gloved flange, the filter device and the mounting plate can be mounted on a portable stand.

Other embodiments include a system for cleaning an interior section of a CVD reactor. The system includes a gloved device such as a gloved flange with a top portion, a suction port, a purge port and an adapter plate, the adapter plate being configured to sealingly couple with a CVD reactor. The gloved flange can include at least one access port having a wall-mounted glove coupled thereto. A filter device configured for operative coupling with the suction port of the gloved flange and having an intake and an exhaust can also be included. In one embodiment, a gas diffuser head is operatively coupled with the gloved flange and facing the interior section of the CVD reactor, the gas diffuser head being in fluid communication with the purge port. A vacuum device can be configured for operative coupling with the exhaust of the filter device, wherein a vacuum is maintained within the gloved box by the vacuum device when the flow flange is coupled to the mounting plate. Alternatively, the gloved device comprises a gloved cylinder with the top portion and adapter portion being separated by a cylindrical portion, with at least one access port that passes through the cylindrical portion.

Various embodiments of the invention comprise a method for cleaning a CVD reactor, the comprising: providing a gloved box situated on a portable stand, the gloved box having at least one side wall equipped with an access port having a wall-mounted glove coupled thereto, the gloved box including a mounting plate coupled to the portable stand, the mounting plate adapted for coupling with a flow flange of the CVD reactor and enabling access to the flow flange with the wall-mounted glove of the glove box, the gloved box including a suction port; providing a first filter having an intake and an exhaust, the intake of the first filter being operatively coupled with the suction port of the gloved box; and providing a set of instructions on a tangible medium. The instructions can instruct the user to remove the flow flange from the reactor chamber, couple the flow flange to the mounting plate of the glove box after removing the flow flange from the reactor chamber, and to connect the exhaust of the first filter to a vacuum source.

In other embodiments, a method including providing a gloved device comprising one of a gloved flange and a gloved cylinder, the gloved device adapted to mount to a reactor chamber of the CVD reactor, the gloved device including a purge port, a suction port and at least one access port, the at least one access port having a wall-mounted glove coupled thereto. The instructions further can further include mounting the gloved device to the reactor chamber after removing the flow flange from the reactor chamber, and connecting the purge port of the gloved device to a gas source. A second filter can also be provided having an intake and an exhaust, the intake of the second filter being operatively coupled with the suction port of the gloved device. The instructions can further instruct the operative coupling of the exhaust of the second filter to a vacuum source. In one embodiment, the operator is instructed to introduce an inert gas purge through the flow flange. The system utilized in this method can also be used to clean more than one CVD reactor in sequence.

In various embodiments of the invention, a heater protection cover can also be provided, with instructions to place the heater protection cover over exposed heating elements after removing the flow flange from the reactor chamber.

### BRIEF DESCRIPTION OF THE DRAWINGS

FIG. 1 is a sectional view of a MOCVD reactor;

FIG. 2 is a perspective view of a flow flange cleaning system in an embodiment of the invention;

FIG. 3 is a perspective view of a gloved flange cleaning system in an embodiment of the invention;

FIG. 3A is sectional view of the gloved flange cleaning system of FIG. 3;

FIG. 4 is a sectional view of a gloved cylinder cleaning system in an embodiment of the invention;

FIG. 5 is a perspective view of a heater protection cover in an embodiment of the invention;

FIG. 5A is a side view of the heater protection cover of FIG. 5;

FIG. 6 is a perspective view of a gas diffuser head in an embodiment of the invention;

FIG. 6A is a section view of the gas diffuser head of FIG. 6; and

FIG. 7 is a flow chart depicting the operation of the flow flange and reactor chamber cleaning systems in an embodiment of the invention.

### DETAILED DESCRIPTION

Referring to FIG. 1, an MOCVD reactor 20 is depicted. The MOCVD reactor comprises a flow flange 22 mounted atop a reactor chamber 24. The reactor chamber 24 includes a gate valve 26. The MOCVD reactor 20 is typically located in a clean room that contains the MOCVD reactor 20 and appurtenances thereto, such as power supplies and computer systems for reactor control. The MOCVD reactor 20 includes heating elements 28 located in a central region of the reactor chamber 24 and an exhaust ring 32 that is generally runs along an interior wall 34 of the reactor chamber and below the heating elements 28. Dust or particles generated during the MOCVD process are typically captured in the exhaust ring 32 so as not to be dislodged by unused processing gases that course through the MOCVD reactor 20 during operation. The MOCVD reactor 20 can also include a spindle 36 that extends through and protrudes above the heating elements 28.

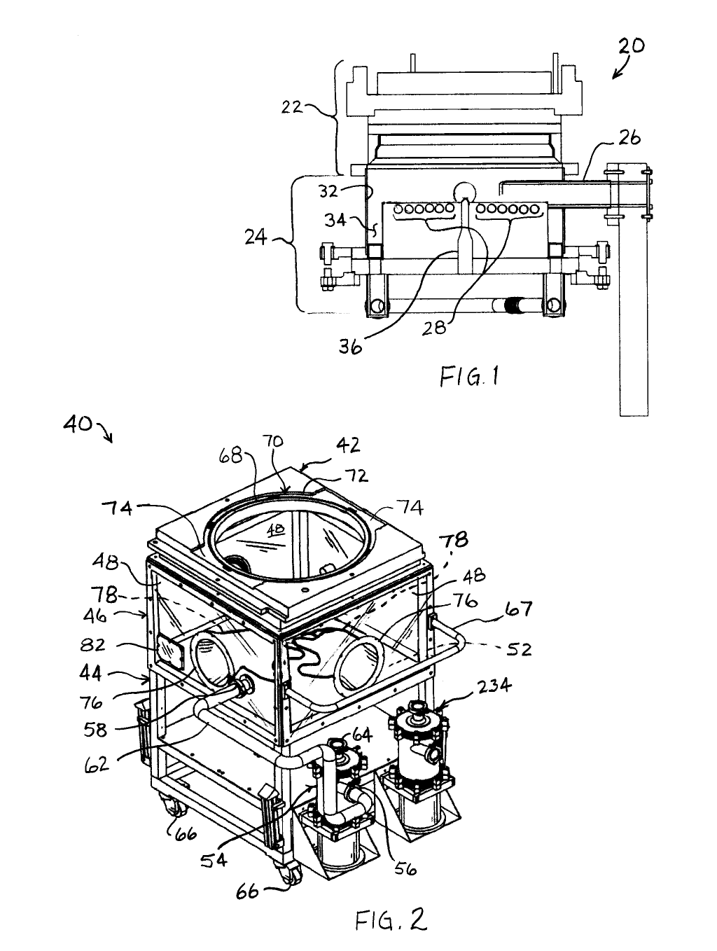

Referring to FIG. 2, a flow flange cleaning system 40 for cleaning the flow flange 22 is depicted in an embodiment of the invention. The flow flange cleaning system 40 can include a mounting plate 42 coupled to a stand 44. The stand 44 includes a gloved box 46 having side walls 48 and a bottom wall 52, with the mounting plate 42 forming the top of the gloved box 46. A filter 54 is mounted to the stand 44, the filter 54 having an intake 56 that is plumbed to a suction port 58 of the gloved box 46 via a suction line 62. The filter 54 also includes an exhaust 64 for coupling with a vacuum source (not depicted). The stand 44 can be mounted on casters 66 and include a handle 67 for transport and positioning of the flow flange cleaning system 40.

In the depicted embodiment, the mounting plate 42 includes a quick coupling 70 with a seat portion 68 and a ridge portion 72, the ridge portion 72 defining accesses 74. The seat portion 68 can include a sealing member 75, such as an o-ring seated in an o-ring gland (as depicted) or a gasket member on the upper face of the seat portion.

The gloved box 46 includes one or more glove ports 76 that enable access to the gloved box 46. The gloved box 46 is so-named because of wall-mounted gloves 78 that are coupled to the side walls 48 of the gloved box 46. The base of the wall-mounted gloves 78 form a seal against the side walls 48 to maintain the integrity of the gloved box 46. In one embodiment, the gloved box 46 includes one or more wiper/tool window(s) 82 disposed on the side walls 48 of the gloved box 46. The wiper/tool window(s) 82 serves as an access that enables the operator to pass tools and wipes through the sidewalls 48 for use by the operator during the cleaning of the flow flange 22. The air that is introduced during passage of the tools into the gloved box 46 is of sufficiently low concentration in the inert-gas purged environment so as not to pose a risk of igniting the pyrophoric residue in the chamber.

In one embodiment, the wall-mounted glove is equipped with a rotatable flange that can be selectively rotated about the access port and clamped into place at any orientation of the operator's choosing. The clamped flange enables the use of a universal glove (i.e., one suitable for use as a right-handed or a left-handed glove) for the wall-mounted gloves 78. In this way, the flange of the universal glove can be selectively rotated 180° for use with either the left or the right hand. The infinitely rotatable flange also enables the operator to orient the wall-mounted glove 78 in any orientation that reduces twisting of the glove in operation (i.e., converting from a left hand operation on a laterally-facing surface to a right handed operation on a substantially downward-facing surface).

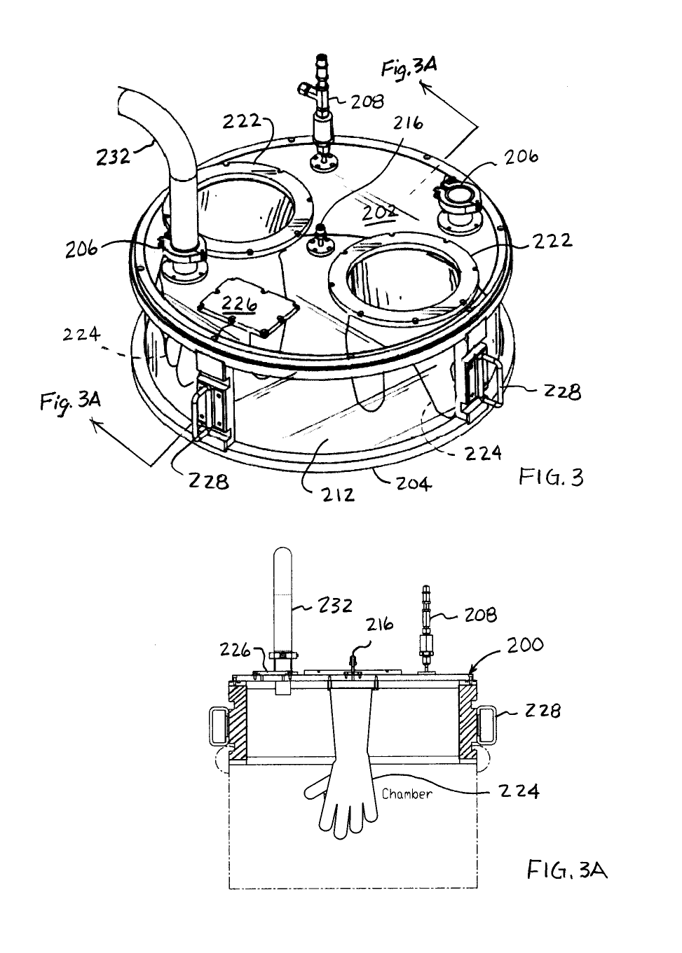

Referring to FIGS. 3 and 3A, a gloved flange 200 for cleaning the reactor chamber 24 is depicted in an embodiment of the invention. In the depicted embodiment, the gloved flange 200 includes an adaptor portion 204 and a cover portion 202 with at least one suction port 206 and a pressure relief valve 208. The gloved flange 200 configuration can included, but does not require, a cylindrical extension 212 between the adaptor portion 204 and the cover portion 202. A purge port 216 provides access through the gloved flange 200, and can be selectively isolated with a valve (not depicted). The cover portion 202 can also include a plurality of glove ports 222, each equipped with a wall-mounted glove 224. Handles 228 can also be mounted to the gloved flange 200 to assist in handling.

In one embodiment, the cover portion 202 is equipped with a wiper/tool window 226. The wiper/tool window 226 serves as an access that enables the operator to pass tools and wipes through the cover portion 202 for use by the operator during the cleaning of the reactor chamber 24. The air that is introduced during passage of the tools or wipes into the reactor chamber 24 is of sufficiently low concentration in the inert-gas purged environment so as not to pose a risk of igniting the pyrophoric residue in the chamber.

The suction port 206 is coupled to a vacuum source (not depicted) via a suction line 232 and the purge port 216 is coupled to an inert gas source (not depicted). In one embodiment, a filter 234 (FIG. 2) is coupled to the suction line 232 between the vacuum source and the suction port 206. Because the cleaning of the reactor chamber 24 takes place only when the flow flange 22 is mounted to the stand 44 and thus when the stand 44 is in proximity of the reactor chamber 24, the filter 234 can be mounted to the stand 44. The gloved box 46 can also include a purge port (not depicted) for introduction of an inert-gas purge.

In one embodiment, the filter 234 is of the same construction as the filter 54. The suction port 206 can be positioned proximate the wall over the exhaust ring 32 of the reactor chamber 24. In another embodiment, there is only one filter (e.g., filter 54) that is equipped with a manifold (not depicted) to switch between sourcing the gloved box 46 and the gloved flange 200. In another embodiment, a single filter can be supplied and the appropriate line (e.g. suction line 62 or 232) from either the gloved box 46 or the gloved flange 200 connected to the intake 56 during use. The intake 56 can also be equipped with a one-way valve, flapper device or other coupling known in the art that substantially seals the filter 54 from exposure to atmospheric air when there is no line connected to the intake 56.

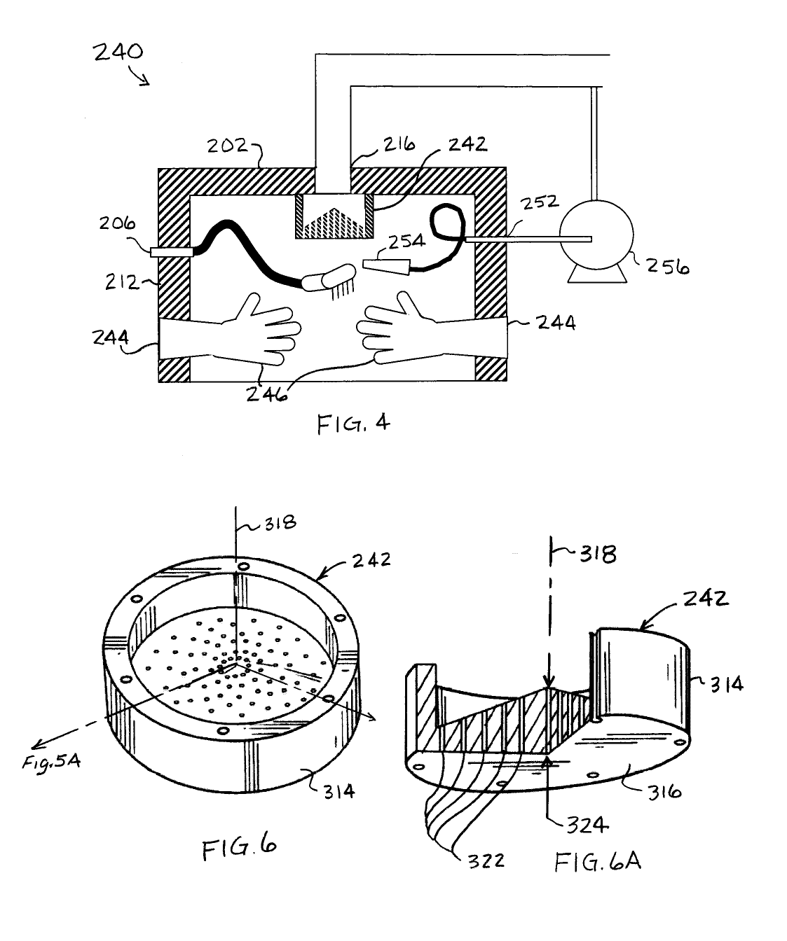

Referring to FIG. 4, a gloved cylinder 240 is depicted in an embodiment of the invention as an alternative to the gloved flange 200. The gloved cylinder 240 can include many of the same appurtenances as the gloved flange 200, including the cover portion 202, suction port 206, cylindrical extension 212 and purge port 216, as seen in the depiction. In one embodiment, a gas diffuser head 242 is coupled to the interior surface of the cover portion 202 and is in fluid communication with the purge port 216. For the gloved cylinder 240, the cylindrical extension 212 includes glove ports 244 to which wall-mounted gloves 246 are operatively coupled. An extension 248 such as a hose or tube can be connected to the part of suction port 206 which faces the interior of the reaction chamber and fitted with various appurtenances 250 such as wands, nozzles, suction brushes and the like.

A pressurized gas port 252 is also depicted in FIG. 4. The pressurized gas port 252 can be used to source a pressurized nozzle 254 for removal of residue from various surfaces. In one embodiment, pressure is supplied by an auxiliary pump 256 that is tapped into the inert gas supply that sources the purge port 216. In another embodiment, the pressurized gas port 252 can be plumbed directly to the inert gas source (not depicted) or include a regulator (not depicted) that regulates the pressure from the inert gas source.

It is noted that, while not depicted in FIGS. 2 and 3, a pressurized gas port with operative pressurized nozzle, as well as an extension with appurtenances coupled to the suction port 206, can also be incorporated into both the gloved box 46 and the gloved flange 200 configurations.

The gloved cylinder 240 can permit a wider field of view within the cleaning chamber than the gloved flange 200. The view through the cover portion 202 is not obstructed with the wall-mounted gloves 224. The posture assumed by the operator in order to insert arms into the gloves is also can, in some instances, be improved with the gloved cylinder 240 over the gloved flange 200.

In operation, the gloved flange 200 and gloved cylinder 240 can be operated in similar fashion. The extension 248 and appurtenances 250 can be used by the operator for cleaning the walls and other coated parts of the reaction chamber. Some dust and debris from the cleaning of the reactor chamber 24 can collect in the exhaust ring 32. The operator can then vacuum up the much of the dust and debris using the extension 248. Any dust and debris remaining after the vacuuming can be wiped clean by the operator. The pressure relief valve 208 opens if the pressure on the inside of the gloved flange 200 exceeds a predetermined differential over ambient pressure, thus providing a safety feature in the event that the evacuation rate of the system becomes inhibited.

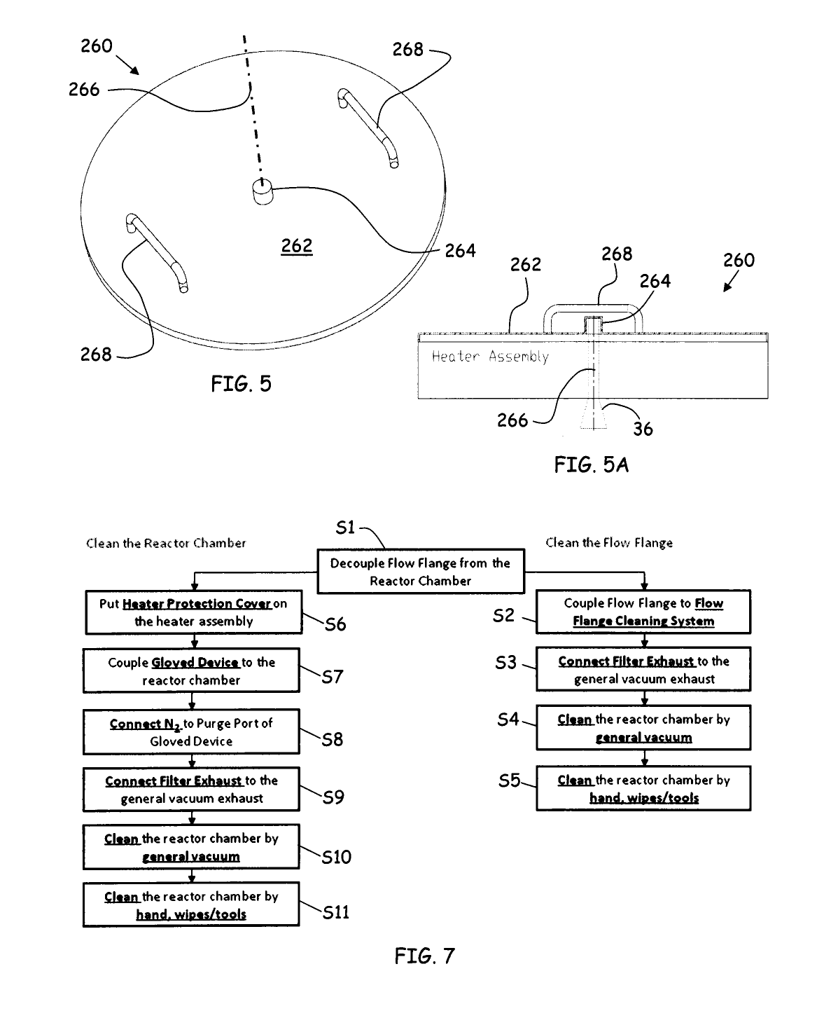

Referring to FIGS. 5 and 5A, a heater protection cover 260 is depicted in an embodiment of the invention. The heater protection cover 260 includes a plate 262 and a spindle port 264 which, in the depicted embodiment, are symmetrical about a central axis 266. Optionally, at least one handle 268 (two depicted) can be affixed to the heater protection cover 260. The heater protection cover 260 can be fabricated from a flexible plastic or fluorocarbon, such as polytetrafluoroethylene (PTFE).

In operation, the heater protection cover 260 is placed over heating elements 28 and spindle 36 of the MOCVD reactor 20 that are exposed upon removal of the flow flange 22. The spindle port 264 of the heater protection cover 260 is sized to accommodate the diameter of the exposed portion of the spindle 36, and can act to center the heater protection cover 260 over the heating elements 28. Functionally, the heater protection cover protects the heating elements 28 and spindle 36 from being damaged during the cleaning operation.

Referring to FIGS. 6 and 6A, the gas diffuser head 242 is described in an embodiment of the invention. The gas diffuser head 242 includes a sidewall portion 314 and a base portion 316 that can be symmetric about a central axis 318. The base portion 316 includes a plurality of flow passages 322 that pass therethrough. In one embodiment, the base portion 316 is of varying thickness, with a maximum thickness 324 at the central axis 318. In one embodiment, the flow passages 322 are substantially parallel to the central axis 318, so that the flow passages 322 proximate the central axis 318 are longer than the flow passages 322 proximate the sidewall portion 314. In the depicted embodiment, the flow passages 322 all have the same diameter.

Functionally, gas that is pressurized within the gas diffuser head 242 favors flow through a shorter passage, at least for passages of equal diameter. Accordingly, in the depicted embodiment, more gas will flow through the passages 322 that are proximate the sidewall portion 314 than will flow through the passages 322 proximate the central axis 318.

In operation, by tailoring the flow for greater flux proximate the sidewall portion 314, the flow profile exiting the gas diffuser head 242 is spread out and favorably flows radially outward along the top of the heater protection cover 260 and down the chamber walls towards the exhaust ring. Such an arrangement inhibits gas from impinging as a concentrated jet on the center of the heater cover 260, which can cause the heater cover 260 to flex and exert an additional force on the heater filaments of the reactor chamber. Often, the heater filaments are quite brittle, and can fracture or shatter under the influence of any additional mechanical load.

Other head designs (not depicted) can be utilized that spread the flow away from the center of the heater protection cover 260. For example, there can be a higher density of flow passages (passages per unit area) proximate the edge of the head than near the centerline. Also, passages of larger diameter can be utilized proximate the edge of the head than those near the centerline. These aspects can be utilized separately or in combination, as well as in combination with the varying thickness design of the gas diffuser head 242 to achieve a desired flow profile.

With respect to the materials of construction of the flow flange cleaning system 40 and the gloved flange 200, at one or more of the side walls 48, the bottom wall 52 of the gloved box 46, the cover portion 202 of the gloved flange 200 and the wiper/tool windows 82 and 226, and the cylindrical extension 212 can be made of a transparent material, such as anti-static acrylic, polycarbonate or glycol modified polyethylene terephthalate. The wall-mounted gloves 78 and 224 are commercially available, for example, from Lab Safety Supply, a subsidiary of W. W. Grainger, Inc., of Chicago, Ill., U.S.A. and comprise a chemically resistant flexible polymer, such as neoprene or butyl rubbers. The filter(s) 54 and/or 234 can be of any suitable type for capturing particulates from a particle-laden flow stream. In general, filters that can capture particles in the 0.01 to 50 micron range, preferably 10 to 40 micron, and more preferably 10 to 20 microns are suitable. Volumetric flow through the filter(s) 54 and/or 234 can range from about 40 to 250 cubic feet per minute, depending on the type of vacuum or exhaust system available as well as the type of filter used. In one embodiment, a cyclone filter is implemented. The centrifugal action of cyclone filters generally separates the particles from the air stream and enables collection of particles for easy and ready disposal. In one embodiment, the filter(s) 54 and/or 234 are readily decoupled from the stand 44 and various connection lines so that the filter filter(s) 54 and/or 234 can be removed for servicing by authorized personnel for disposal of the pyrophoric contents.

Referring to FIG. 7, operation of the flow flange cleaning system 40 and the reactor chamber cleaning flange 200 is now described. The flow flange cleaning system 40 of the depicted embodiment is positioned proximate the MOCVD reactor 20. The MOCVD reactor 20 is opened and the flow flange 22 decoupled from the reactor chamber 24 (step S1) and coupled to the flow flange cleaning system 40 (step S2). In the various embodiments, the flow flange 22 is clamped to the flow flange cleaning system 40. In the depicted embodiment, tabs on the flow flange 22 are aligned with the accesses 40 of the mounting plate 42 so that the flow flange 22 is seated against the seat portion 68 of the quick coupling 70. The flow flange 22 is then rotated so that the tabs are captured between the ridge portion 72 and the seat portion 68 to secure the flow flange 22 to the mounting plate 42. The flow flange 22 is then cleaned by hand using the wall-mounted gloves 78 to operate the general vacuum (step S4) and various wipes and tools (step S5).

Any of a variety of alternative mounting apparatuses and techniques can be used to mount and seal the flow flange 22 to the mounting plate 42. In one embodiment, toggle clamps are positioned around the outer perimeter of the seat portion 68 and are used to releasably secure the flow flange to the seat portion 68. An example of a toggle clamp that is suited for this purpose is the Model #2010-U Workholding Toggle Clamp manufactured by the DE-STA-CO Company, a Dover Resources Company headquartered in Auburn Hills, Mich., U.S.A. In another embodiment, the mounting plate can be designed to accommodate c-clamps for securing the flow flange 22 to the seating portion.

To clean the reactor chamber, the heater protection cover 260 is first place over the exposed heater assembly (step S6), as depicted in FIG. 6A. Then the gloved device (e.g., the gloved flange 200 or the gloved cylinder 240) is coupled to the open, upper end of the reactor chamber 24 (step S7) and clamped thereto, as depicted in FIG. 3A. An inert gas source (usually nitrogen) is operatively coupled with the purge port 216 (step S8). A vacuum source (not depicted) is operatively coupled with the exhaust port of the filter (e.g., filter 54 or 234) (step S9). The reactor chamber 24 is then cleaned by hand using the general vacuum wall-mounted gloves 224 and various wipes and tools (steps S10 and S11).

In one embodiment, a set of instructions that includes various steps discussed above for the setup and use of the flow flange cleaning system 40 and/or the gloved flange 200 or gloved cylinder 240 is provided along with the respective system(s) on a tangible medium.

References to relative terms such as upper and lower, front and back, left and right, or the like, are intended for convenience of description and are not contemplated to limit the invention, or its components, to any specific orientation. All dimensions depicted in the figures may vary with a potential design and the intended use of a specific embodiment of this invention without departing from the scope thereof.

Each of the additional figures and methods disclosed herein may be used separately, or in conjunction with other features and methods, to provide improved devices, systems and methods for making and using the same. Therefore, combinations of features and methods disclosed herein may not be necessary to practice the invention in its broadest sense and are instead disclosed merely to particularly describe representative embodiments of the invention.

For purposes of interpreting the claims for the present invention, it is expressly intended that the provisions of Section 112, sixth paragraph of 35 U.S.C. are not to be invoked unless the specific terms “means for” or “step for” are recited in the subject claim.

1. A system for cleaning a CVD flow flange, the flow flange having a chamber-facing surface, the system comprising:
a gloved box comprising one or more walls, at least one of said one or more walls including a suction port and an access port, said access port having a wall-mounted glove coupled thereto;
a filter device including an intake and an exhaust, said intake of said filter device being configured for operative coupling with said suction port of said gloved box;
a mounting plate adapted to releasably couple said flow flange to said gloved box such that said chamber-facing surface of said flow flange is substantially sealed against said mounting plate; and
one or more retrievable cleaning implements adapted to clean said chamber facing surface of said flow flange.

2. The system of claim 1, further comprising:
a vacuum device configured for operative coupling with said exhaust of said filter device, wherein a vacuum is maintained within said gloved box by said vacuum device when said flow flange is coupled to said mounting plate.

3. The system of claim 1, wherein said gloved flange box, said filter device and said mounting plate being mounted on a portable stand.

4. A system for cleaning an interior section of a CVD reactor comprising:
a gloved flange comprising a top portion, a suction port, a purge port and an adapter plate, said adapter plate being configured to sealingly couple with a CVD reactor, said gloved flange including at least one access port having a wall-mounted glove coupled thereto;
a filter device including an intake and an exhaust, said intake of said filter device being configured for operative coupling with said suction port of said gloved flange; and
a gas diffuser head operatively coupled with said gloved flange and facing said interior section of said CVD reactor, said gas diffuser head being in fluid communication with said purge port.

5. The system of claim 4, further comprising:
a vacuum device configured for operative coupling with said exhaust of said filter device, wherein a vacuum is maintained within said gloved box by said vacuum device when said flow flange is coupled to said mounting plate.

6. The system of claim 4, wherein at least one of said suction port and said purge port passes through said top portion.

7. A system for cleaning an interior section of a CVD reactor comprising:
a gloved cylinder comprising a top portion and an adapter portion separated by a cylindrical portion, said adapter portion being configured to sealingly couple with a CVD reactor, said gloved cylinder including at least one access port that passes through said cylindrical portion, said access port being having a wall-mounted glove coupled thereto, said gloved cylinder further comprising a suction port and a purge port;
a filter device including an intake and an exhaust, said intake of said filter device being configured for operative coupling with said suction port of said gloved cylinder; and
a gas diffuser head operatively coupled with said gloved cylinder and facing said interior section of said CVD reactor, said gas diffuser head being in fluid communication with said purge port.

8. The system of claim 7, further comprising:
a vacuum device configured for operative coupling with said exhaust of said filter device for maintaining a sub-ambient pressure within said reactor chamber when said gloved cylinder is coupled to said reactor chamber.

9. The system of claim 7, wherein at least one of said suction port and said purge port passes through said top portion.

10. A method for cleaning a CVD reactor, comprising:
providing a gloved box situated on a portable stand, said gloved box having at least one side wall equipped with an access port having a wall-mounted glove coupled thereto, said gloved box including a mounting plate coupled to said portable stand, said mounting plate adapted for coupling with a flow flange of said CVD reactor and enabling access to said flow flange with said wall-mounted glove of said glove box, said gloved box including a suction port;
providing a first filter having an intake and an exhaust, said intake of said first filter being operatively coupled with said suction port of said gloved box;
providing a set of instructions on a tangible medium, said instructions including:
coupling said flow flange to said glove box; and
connecting said exhaust of said first filter to a vacuum source.

11. The method of claim 10, further comprising:
providing a gloved device, said gloved device adapted to mount to a reactor chamber of said CVD reactor, said gloved device including a purge port, a suction port and at least one access port, said at least one access port having a wall-mounted glove coupled thereto;
wherein said instructions further comprise:
mounting said gloved device to said reactor chamber; and
connecting said purge port of said gloved device to a gas source.

12. The method of claim 11, further comprising:
providing a second filter having an intake and an exhaust, said intake of said second filter being operatively coupled with said suction port of said gloved device, and
wherein said instructions provided in the step of providing said set of instructions further comprise operatively coupling said exhaust of said second filter to a vacuum source.

13. The method of claim 10, further comprising:
providing a heater protection cover,
wherein said instructions further comprise:
placing said heater protection cover over exposed heating elements.

14. The method of claim 10, wherein said instructions further comprise:
introducing an inert gas purge through said flow flange.

15. The method of claim 9, further comprising:
using said gloved box situated on said portable stand provided in the step of providing a gloved box to clean more than one CVD reactor in sequence.

16. A method for cleaning a CVD reactor, comprising:
providing a gloved device, said gloved device adapted to mount to a reactor chamber of said CVD reactor, said gloved device including a purge port, a suction port and at least one access port, said at least one access port having a wall-mounted glove coupled thereto;
providing a first filter having an intake and an exhaust, said intake of said first filter being operatively coupled with said suction port of said gloved device;
providing a set of instructions on a tangible medium, said instructions including:
removing said flow flange from said reactor chamber;
mounting said gloved device to said reactor chamber after removing said flow flange from said reactor chamber;
connecting said purge port of said gloved device to an inert gas source; and
connecting said exhaust of said first filter to a vacuum source.

17. The method of claim 16, further comprising:
providing a gloved box situated on a portable stand, said gloved box having at least one side wall equipped with an access port having a wall-mounted glove coupled thereto, said gloved box including a mounting plate coupled to said portable stand, the mounting plate adapted for coupling with a flow flange of said CVD reactor and enabling access to said flow flange with said wall-mounted glove of said glove box, said gloved box including a suction port;
providing a second filter having an intake and an exhaust, said intake of said second filter being operatively coupled with said suction port of said gloved box;
providing a set of instructions on a tangible medium, said instructions including:
coupling said flow flange to said mounting plate of said glove box after removing said flow flange from said reactor chamber; and
connecting said exhaust of said second filter to a vacuum source.

18. The method of claim 16, further comprising:
providing a heater protection cover,
wherein said instructions further comprise:
placing said heater protection cover over exposed heating elements after removing said flow flange from said reactor chamber.

19. The method of claim 11, wherein said intake of said first filter provided in the step of providing said first filter is operatively coupled with said suction port of said gloved device.

20. The method of claim 10, wherein said gloved device provided in the step of providing a gloved device comprises one of a gloved flange and a gloved cylinder.

21. The method of claim 16, wherein said gloved device provided in the step of providing a gloved device comprises one of a gloved flange and a gloved cylinder.
